(19) United States
(12) Patent Application Publication
(10) Pub. No.: US 2019/0353951 A1
(43) Pub. Date: Nov. 21, 2019

(54) LAMINATE, AND DISPLAY DEVICE

(71) Applicant: AGC Inc., Chiyoda-ku (JP)

(72) Inventors: Ryo HOKARI, Tokyo (JP); Atsushi INOUE, Tokyo (JP); Yasuhiro INOUE, Tokyo (JP)

(73) Assignee: AGC Inc., Chiyoda-ku (JP)

(21) Appl. No.: 16/412,484

(22) Filed: May 15, 2019

(30) Foreign Application Priority Data
May 17, 2018 (JP) 2018-095184

(51) Int. Cl. G02F 1/1333; B32B 17/10

(52) U.S. Cl. CPC G02F 1/133308; B32B 17/10761; C09J 2201/40; G02F 2001/133331; C09J 2203/318; G02F 2202/28

(57) ABSTRACT

The present invention relates to a laminate including a first glass, an intermediate film and a second glass in this order, the laminate satisfying the following Expressions (1) to (4):

B₁=b₁+b₂+b₃<2.90, (1)

b₁=(0.0665t₂+0.4378)t₁+(−0.2367t₂+0.5152), (2)

b₂=−0.16 Ln(x)+0.5152, and (3)

b₃=(0.0785x²−0.1135x+0.0182)t₃+(−0.134 Ln(x)+0.5617), (4)

in which t₁ is a thickness of the first glass in millimeter unit, t₂ is a thickness of the second glass in millimeter unit, t₃ is a thickness of the intermediate film in millimeter unit, and x is a storage shear elastic modulus of the intermediate film at a temperature of 25° C. and a frequency of 10 kHz in GPa unit.

### FIELD OF THE INVENTION

The present invention relates to a laminate, and a display device.

### BACKGROUND OF THE INVENTION

In the background art, a cover member is used in a display device in order to protect a display panel such as a liquid crystal panel (see Patent Document 1).

Patent Document 1: WO 2011/148990

### SUMMARY OF THE INVENTION

An in-vehicle display device such as a car navigation system is mounted on a vehicle such as a car.

In some of such in-vehicle display devices, a cover member for a display panel is used, and a laminate such as a laminated glass is used as the cover member.

The laminate used as the cover member for the in-vehicle display device demands shock resistance excellent enough to prevent the laminate from being broken by a head of a passenger when a collision accident occurs in the vehicle, or to prevent broken pieces of the laminate from scattering if the laminate is broken.

Therefore, an object of the present invention is to provide a laminate excellent in shock resistance, and a display device using the laminate.

As a result of intensive studies, the present inventors found that the aforementioned object can be attained by the following configurations.

Namely, the present invention provides the following [1] to [18].

[1] A laminate including a first glass, an intermediate film and a second glass in this order, the laminate satisfying the following Expressions (1) to (4):

B₁=b₁+b₂+b₃<2.90, (1)

b₁=(0.0665t₂+0.4378)t₁+(−0.2367t₂+0.5152), (2)

b₂=−0.16 Ln(x)+0.5152, and (3)

b₃=(0.0785x²−0.1135x+0.0182)t₃+(−0.134 Ln(x)+0.5617), (4)

in which t₁ is a thickness of the first glass in millimeter unit, t₂ is a thickness of the second glass in millimeter unit, t₃ is a thickness of the intermediate film in millimeter unit, and x is a storage shear elastic modulus of the intermediate film at a temperature of 25° C. and a frequency of 10 kHz in GPa unit.

[2] The laminate according to [1], further satisfying the following Expressions (5) to (7):

B₂=b₄+b₅≤3.82, (5)

b₄=(−0.0612t₁+0.1357)t₂−0.0596t₁²+0.0769t₁+1.1698, and (6)

b₅=−0.1079t₃+0.1282 Ln(x)+1.5774+(0.0047t₃+0.1231)Ln(x)−0.0963t₃+1.5660. (7)

[3] The laminate according to [2], further satisfying the following Expression (8) as to the B₂:

B₂<3.77. (8)

[4] The laminate according to any one of [1] to [3], in which at least one of the first glass and the second glass is a chemically-strengthened glass.

[5] The laminate according to any one of [1] to [3], in which both the first glass and the second glass are chemically-strengthened glasses.

[6] The laminate according to [4] or [5], in which the chemically-strengthened glass has a compressive stress layer, the compressive stress layer has a thickness of 10 μm or more, and the compressive stress layer has a surface compressive stress of 500 MPa or more.

[7] The laminate according to any one of [1] to [6], in which the thickness t₁ of the first glass is 0.5 mm or more and 3 mm or less. [8] The laminate according to any one of [1] to [7], in which the thickness t₂ of the second glass is 0.5 mm or more and 3 mm or less.

[9] The laminate according to any one of [1] to [8], in which the storage shear elastic modulus x of the intermediate film is 0.040 GPa or more and 0.800 GPa or less.

[10] The laminate according to any one of [1] to [9], in which the thickness t₃ of the intermediate film is 0.1 mm or more and 5 mm or less.

[11] The laminate according to any one of [1] to [10], having an adhesive strength between the first glass and the intermediate film of 0.1 N/25 mm or more.

[12] The laminate according to any one of [1] to [11], having an adhesive strength between the second glass and the intermediate film of 0.1 N/25 mm or more.

[13] The laminate according to any one of [1] to [12], in which a resin constituting the intermediate film includes at least one selected from the group consisting of polyvinyl butyral, ethylene vinyl acetate, and cycloolefin.

[14] The laminate according to any one of [1] to [13], having a luminous transmittance of 20% or more and 85% or less.

[15] The laminate according to any one of [1] to [14],

in which the first glass includes a first main face that is one of main faces thereof, and a second main face that is the other main face,

the second main face is bonded to the intermediate film, and

the laminate includes a functional layer provided on the first main face.

[16] The laminate according to [15], in which the functional layer includes at least one layer selected from the group consisting of an antireflection layer, an antiglare layer and an antifouling layer.

[17] A display device including:

a display panel; and

the laminate according to any one of [1] to [16],

in which the laminate is a cover member that covers the display panel.

[18] The display device according to [17], in which the display device is an in-vehicle display device.

According to the present invention, a laminate excellent in shock resistance, and a display device using the laminate can be provided.

### BRIEF DESCRIPTION OF THE DRAWINGS

FIG. 1 is a cross-sectional view illustrating a display device according to an embodiment of the present invention.

FIG. 2 is a cross-sectional view illustrating a laminate according to an embodiment of the present invention.

FIG. 3 is a cross-sectional view illustrating a test body.

FIG. 4 is a plan view illustrating the test body.

### DETAILED DESCRIPTION OF THE INVENTION

An embodiment of the present invention will be described below. However, the present invention is not limited to the following embodiment. Various modifications and replacements can be made on the following embodiment without departing from the scope of the present invention.

A laminate according to the embodiment of the present invention will be also referred to as a “laminate of the invention” conveniently. Similarly, a display device according to the embodiment of the present invention will be also referred to as a “display device of the invention” conveniently.

### [Display Device]

FIG. 1 is a cross-sectional view illustrating a display device 100 according to an embodiment of the invention. The display device 100 is an in-vehicle display device such as a car navigation system.

The display device 100 includes a housing 106 that houses some members. A backlight unit 102 is disposed on a housing bottom plate 107 that is a bottom plate of the housing 106. A display panel 104 that is a liquid crystal panel is disposed on the backlight unit 102.

The configurations of the display panel 104 and the backlight unit 102 are not particularly limited, but known configurations may be used. For example, the display device 100 may be a display device including an organic EL (Electro Luminescence) panel or an electronic ink type panel, and may include a touch panel or the like. The material or the like of the housing 106 including the housing bottom plate 107 is also not particularly limited.

As shown in FIG. 1, in the display device 100, a laminate 1 as a cover member for the display panel 104 is laminated on the display panel 104 by an adhesive layer 14.

A layer including a transparent resin obtained by curing a liquid curable resin composition can be used as the adhesive layer 14. The adhesive layer 14 may be an OCA (Optical Clear Adhesive) film or an OCA tape. The thickness of the adhesive layer 14 is, for example, 5 μm to 400 μm, and preferably 50 μm to 200 μm.

### [Laminate]

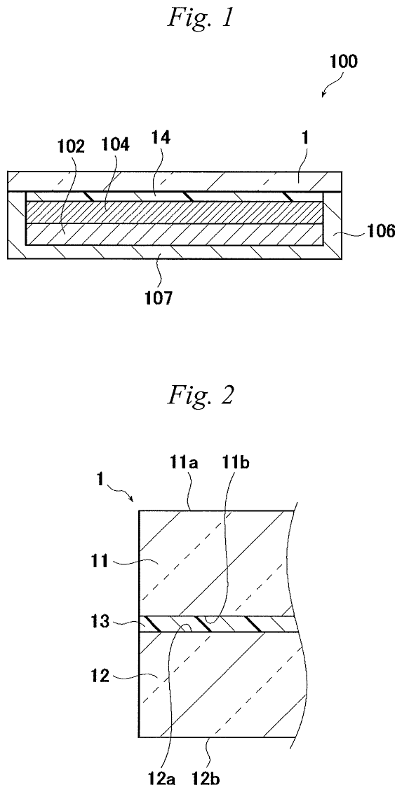

FIG. 2 is a cross-sectional view illustrating the laminate 1 according to the embodiment of the invention. The laminate 1 is a so-called “laminated glass” that includes a first glass 11, an intermediate film 13 and a second glass 12 in this order. In particular, the first glass 11 and the second glass 12 are bonded to each other through the intermediate film 13.

The first glass 11 is a glass plate that includes a first main face 11a that is one of main faces of the first glass plate 11, and a second main face 11b that is the other main face. The second main face 11b of the first glass 11 is bonded to the intermediate film 13.

The second glass 12 is a glass plate that includes a first main face 12a that is one of main faces of the second glass plate 12, and a second main face 12b that is the other main face. The first main face 12a of the second glass 12 is bonded to the intermediate film 13.

The laminate 1 used as a cover member for the display device 100 (see FIG. 1) is laminated on the display panel 104 so that the second glass 12 faces the display panel 104 (see FIG. 1).

### (Expressions (1) to (4))

A cover member for an in-vehicle display device demands shock resistance excellent enough to prevent the cover member from being broken by a head of a passenger when a collision accident occurs in the vehicle, or to prevent broken pieces of the cover member from scattering if the cover member is broken.

The laminate of the invention satisfies the following Expressions (1) to (4) when t₁ designates the thickness of the first glass in millimeter unit, t₂ designates the thickness of the second glass in millimeter unit, t₃ designates the thickness of the intermediate film in millimeter unit, and x designates the storage shear elastic modulus of the intermediate film at a temperature of 25° C. and a frequency of 10 kHz in GPa unit. As a result, the laminate of the invention has excellent shock resistance. In particular, breaking in the first glass is suppressed and broken pieces of the second glass can be prevented from scattering even if the second glass is broken.

In the following description, the storage shear elastic modulus x of the intermediate film at a temperature of 25° C. and a frequency of 10 kHz will be referred to as “elastic modulus x of the intermediate film” or “elastic modulus x” simply.

B₁=b₁+b₂+b₃<2.90, (1)

b₁=(0.0665t₂+0.4378)t₁+(−0.2367t₂+0.5152), (2)

b₂=−0.16 Ln(x)+0.5152, and (3)

b₃=(0.0785x²−0.1135x+0.0182)t₃+(−0.134 Ln(x)+0.5617), (4)

The technical meanings of Expressions (1) to (4) will be explained.

First, in order to prevent the first glass from breaking, it is required that stress (back surface stress) generated in the back surface of the first glass in case where impact is applied thereto is low.

The present inventors simulated head impactor tests (HITs) in which the thickness t₁ of the first glass and the thickness t₂ of the second glass were fixed to 1.1 mm respectively, and the elastic modulus x of the intermediate film was varied.

PAM-CRASH (made by ESI Japan Ltd.) which was a commercially available analysis program was used in the simulation. The HITs were simulated using the same conditions as in “Evaluation of Shock Resistance by Head Impactor Test” in Examples which will be described later (the same thing can be applied to the following description).

As a result, it was found that an index b₂ of back surface stress of the first glass in case where impact is applied decreases as the elastic modulus x of the intermediate film increases. Specifically, Expression (3) “b₂=−0.16 Ln(x)+0.5152” was found. “Ln(x)” is a natural logarithm of x using e as a base.

Next, the present inventors simulated HITs in which the thickness t₁ of the first glass and the thickness t₂ of the second glass were fixed to 1.1 mm respectively, the elastic modulus x of the intermediate film was fixed to 0.044 GPa, 0.088 GPa, 0.0176 GPa, 0.352 GPa and 0.704 GPa, and the thickness t₃ of the intermediate film was varied to 0.4 mm, 1.2 mm, 2.0 mm, 3.2 mm, 3.6 mm and 4.0 mm. As a result, it was found that an index b₃ of back surface stress of the first glass in case where impact is applied varies in accordance with the elastic modulus x of the intermediate film and the thickness t₃ of the intermediate film. Specifically, Expression (4) “b₃=(0.0785x²−0.1135x+0.0182)t₃+(−0.134 Ln(x)+0.5617)” was found.

Next, the present inventors simulated HITs in which the elastic modulus x of the intermediate film was fixed to 0.176 GPa, the thickness t₂ of the second glass was set at 0.7 mm, 1.1 mm and 2.0 mm, and the thickness t₁ of the first glass was varied. As a result, it was found that an index b₁ of back surface stress of the first glass in case where impact is applied decreases linearly as the thickness t₁ of the first glass was reduced. Specifically, Expression (2) “b₁=(0.0665t₂+0.4378)t₁+(−0.2367t₂+0.5152)” was found.

Further, the present inventors simulated further HITs. As a result, it was found that breaking in the first glass can be suppressed when a total value B₁ of the aforementioned indexes b₁, b₂ and b₃ of back surface stress of the first glass is smaller than 2.90, that is, Expression (1) “B₁=b₁+b₂+b₃<2.90” is satisfied.

### (Expressions (5) to (7))

Further, it is preferable that the laminate of the invention satisfies the following Expressions (5) to (7). As a result, the laminate of the invention is more excellent in shock resistance. Specifically, not only the first glass but also second glass can be suppressed from breaking.

B₂=b₄+b₅≤3.82, (5)

b₄=(−0.0612t₁+0.1357)t₂−0.0596t₁²+0.0769t₁+1.1698, and (6)

b₅=−0.1079t₃+0.1282 Ln(x)+1.5774+(0.0047t₃+0.1231)Ln(x)−0.0963t₃+1.5660. (7)

Technical meanings of Expressions (5) to (7) will be explained. First, in order to prevent the second glass from breaking, it is demanded that stress (back surface stress) generated in the back surface of the second glass in case where impact is applied thereto is low.

The present inventors simulated HITs in which the thickness t₁ of the first glass and the thickness t₂ of the second glass were fixed to 1.1 mm respectively, the elastic modulus x of the intermediate film was set at 0.044 GPa, 0.088 GPa, 0.176 GPa, 0.352 GPa and 0.704 GPa, and the thickness t₃ of the intermediate film was varied. As a result, it was found that an index c₄ of back surface stress of the second glass in case where impact is applied decreases linearly as the thickness t₃ of the intermediate film increases. Specifically, an expression “c₄=−0.1079t₃+0.1282 Ln(x)+1.5774” was found.

In addition, the present inventors simulated HITs in which the thickness t₁ of the first glass and the thickness t₂ of the second glass were fixed to 1.1 mm respectively, the thickness t₃ of the intermediate film was set at 0.4 mm, 2 mm, 3.2 mm, 3.6 mm and 4 mm, and the elastic modulus x of the intermediate film was varied. As a result, it was found that an index d₄ of back surface stress of the second glass in case where impact is applied decreases as the elastic modulus x of the intermediate film decreases. Specifically, an expression “d₄=(0.0047t₃+0.1231)Ln(x)−0.0963t₃+1.5660” was found.

That is, as for an index b₅ (=c₄+d₄) of back surface stress of the second glass in case where impact is applied, Expression (7) “b₅=−0.1079t₃+0.1282 Ln(x)+1.5774+(0.0047t₃+0.1231)Ln(x)−0.0963t₃+1.5660” was found.

Next, the present inventors simulated HITs in which the thickness t₃ of the intermediate film was fixed to 0.4 mm, the elastic modulus x of the intermediate film was fixed to 0.176 GPa, the thickness t₁ of the first glass was set at 0.7 mm, 1.1 mm and 2.0 mm, and the thickness t₂ of the second glass was varied. As a result, it was found that an index b₄ of back surface stress of the second glass in case where impact is applied decreases as the thickness t₂ of the second glass decreases. Specifically, Expression (6) “b₄=(−0.0612t₁+0.1357)t₂−0.0596t₁²+0.0769t₁+1.1698” was found.

The present inventors simulated further HITs. As a result, it was found that breaking in the second glass can be suppressed when a total value B₂ of the aforementioned indexes b₄ and b₅ of back surface stress of the second glass is not more than 3.82, that is, Expression (5) “B₂=b₄+b₅≤3.82” is satisfied.

### (Expression (8))

In order to further suppress breaking in the second glass, it is more preferable that the B₂ is less than 3.77. That is, it is more preferable that Expression (8) “B₂<3.77” is satisfied.

### (First Glass and Second Glass)

Next, the first glass and the second glass will be explained in detail.

### «Chemically-Strengthened Glass»

It is preferable that at least one of the first glass and the second glass is a chemically-strengthened glass, and it is more preferable that both the first glass and the second glass are chemically-strengthened glasses.

Incidentally, when at least one of the first glass and the second glass is a chemically-strengthened glass, it is preferable that the first glass is a chemically-strengthened glass.

A compressive stress layer is formed in the surface of the chemically-strengthened glass. The thickness of the compressive stress layer (DOL) is, for example, 10 μm or more, preferably 15 μm or more, more preferably 25 μm or more, and further more preferably 30 μm or more.

Surface compressive stress (CS) in the compressive stress layer of the chemically-strengthened glass is, for example, 500 MPa or more, preferably 650 MPa or more, and more preferably 750 MPa or more. The upper limit of the surface compressive stress is not particularly limited, but it is, for example, 1,200 MPa or less.

According to a typical example of a method for performing chemically strengthening treatment on a glass to obtain a chemically-strengthened glass, the glass is immersed in KNO₃ molten salt to be subjected to ion exchange treatment, and then cooled down to the vicinity of a room temperature. Treatment conditions such as the temperature of the KNO₃ molten salt, the immersing time, etc. may be set to adjust the surface compressive stress and the thickness of the compressive stress layer to desired values.

Examples of kinds of glasses for the first glass and the second glass include soda-lime glass, and aluminosilicate glass (SiO₂—Al₂O₃—Na₂O based glass). Among them, aluminosilicate glass is preferred from the viewpoint of strength.

As the glass material, for example, a glass material including, in terms of mol % based on the oxides, from 50% to 80% of SiO₂, from 1% to 20% of Al₂O₃, from 6% to 20% of Na₂O, from 0% to 11% of K₂O, from 0% to 15% of MgO, from 0% to 6% of CaO, and from 0% to 5% of ZrO₂, may be mentioned.

A glass based on aluminosilicate glass and for use in chemically strengthening (for example, “Dragontrail (registered trademark)” made by AGC Inc.) can be also used suitably.

### «Thickness»

The thickness t₁ of the first glass is preferably 0.5 mm or more and 3 mm or less, and more preferably 0.7 mm or more and 2 mm or less.

The thickness t₂ of the second glass is preferably 0.5 mm or more and 3 mm or less, and more preferably 0.7 mm or more and 2 mm or less.

When the thickness t₁ of the first glass or the thickness t₂ of the second glass is set within the aforementioned range, the laminate of the invention can keep strength required as a cover member while, for example, the weight of the display device of the invention as a final product can be reduced easily. In addition, excellent appearance can be obtained easily.

### «Size and Shape»

It is preferable that the first glass and the second glass have the same size and the same shape (as size and shape in planar view of the laminate of the invention).

The shape of the display device is generally a rectangle such as an oblong. In such a case, the first glass and the second glass are also rectangular.

When the first glass and the second glass are rectangular, each of the glasses is, for example, from 100 mm to 900 mm long in its longer side direction and from 40 mm to 500 mm long in its shorter side direction.

Edge portions of the first glass and the second glass may be subjected to chamfering. Each of the first glass and the second glass may have a bent portion in its part, or may have a curved shape as a whole.

### (Intermediate Film)

Resin constituting the intermediate film is not particularly limited. Resins known in the background art can be used. For example, at least one kind selected from the group consisting of polyvinyl butyral (PVB), ethylene vinyl acetate (EVA), and cycloolefin (COP) can be used suitably.

The thickness t₃ of the intermediate film is preferably 0.1 mm or more and 5 mm or less, and more preferably 0.1 mm or more and 1.5 mm or less. When the thickness t₃ of the intermediate film is made not less than the aforementioned lower limit value, the laminate of the invention can be produced with good yield. When the thickness t₃ of the intermediate film is made not more than the aforementioned upper limit value, the appearance of the laminate of the invention can be kept excellent, and when a touch sensor or the like is combined, the sensing sensitivity of the touch sensor can be secured.

The storage shear elastic modulus x (elastic modulus x) of the intermediate film at a temperature of 25° C. and a frequency of 10 kHz is, for example, 0.040 GPa or more and 0.800 GPa or less, and more preferably 0.050 GPa or more and 0.176 GPa or less from the viewpoint of availability of resin constituting the intermediate film.

The elastic modulus x of the intermediate film is obtained by measuring frequency dispersion data at various temperatures by Ares G2 Rheometer made by TA Instruments and creating a master curve by Analysis Software Trios attached thereto.

### (Adhesive Strength)

An adhesive strength between the first glass and the intermediate film is preferably 0.1 N/25 mm or more, more preferably 1 N/25 mm or more, and further more preferably 10 N/25 mm or more. When the adhesive strength between the first glass and the intermediate film is made not less than the aforementioned lower limit value, the first glass and the intermediate film can be prevented from being separated from each other easily even if the laminate of the invention receives an impact. Thus, the first glass can be further prevented from breaking, and broken pieces thereof can be prevented from scattering even if the first glass is broken.

An adhesive strength between the second glass and the intermediate film is preferably 0.1 N/25 mm or more, more preferably 1 N/25 mm or more, and further more preferably 10 N/25 mm or more. When the adhesive strength between the second glass and the intermediate film is made not less than the aforementioned lower limit value, the second glass and the intermediate film can be prevented from being separated from each other easily even if the laminate of the invention receives an impact.

The upper limit value of the adhesive strength between the first glass and the intermediate film and the upper limit value of the adhesive strength between the second glass and the intermediate film are not particularly limited, but they are preferably 100 N/25 mm or less, and more preferably 95 N/25 mm or less. When the adhesive strength between each glass and the intermediate film is not more than the aforementioned upper limit value, the glass can be further prevented from breaking easily even if the laminate of the invention receives an impact, and broken pieces thereof can be further prevented from scattering even if the glass is broken since the intermediate film itself can be prevented from tearing easily.

The aforementioned adhesive strength can be obtained by a tensile test where a peel angle is 90°.

### (Luminous Transmittance)

Luminous transmittance of the laminate of the invention is preferably 20% or more and 85% or less, and more preferably 50% or more and 80% or less. When the luminous transmittance is within the aforementioned range, the laminate can have appropriate light-absorbing performance. Therefore, in the display device of the invention using the laminate of the invention as a cover member, it is possible to suppress reflection at the interface between the laminate of the invention and the adhesive layer. Thus, photopic contrast can be improved.

Transmittance of incident light from the visible side (first glass side) is measured over the wavelength range of from 300 nm to 1,300 nm with a spectrophotometer (UV3150PC made by Shimadzu Corporation) according to JIS Z 8722:2009, so as to obtain luminous transmittance in a visible light wavelength range (380 nm to 780 nm).

### (Functional Layer)

The laminate of the invention preferably includes a functional layer on the first main face of the first glass.

The functional layer may be formed by treatment performed on a surface layer of the first glass, or may be formed by lamination of another layer on the surface of the first glass.

Examples of such functional layers include an antireflection layer, an antiglare layer, an antifouling layer, and a light shielding layer. It is preferable that the functional layer includes at least one layer selected from the group consisting of an antireflection layer, an antiglare layer, and an antifouling layer.

### «Antireflection Layer»

The antireflection layer provides an effect of reduction in reflectivity, and has an effect of reduction in glare caused by reflection of light. When the antireflection layer is provided, the transmittance of light from a display panel can be improved so that an image displayed on the display panel can be made clear.

The material of the antireflection layer is not particularly limited, but various materials can be used as long as they are materials capable of suppressing reflection of light. For example, the antireflection layer may have a configuration in which a high refractive index layer and a low refractive index layer are stacked. Here, the high refractive index layer is a layer whose refractive index is 1.9 or higher at a wavelength of 550 nm, and the low refractive index layer is a layer whose refractive index is 1.6 or lower at the wavelength of 550 nm.

The antireflection layer may be formed to include a single high refractive index layer and a single low refractive index layer. However, the antireflection layer may be configured to include two or more high refractive index layers and two or more low refractive index layers. When the antireflection layer includes two or more high refractive index layers and two or more low refractive index layers, it is preferable that the antireflection layer has a form in which the high refractive index layers and the low refractive index layers are stacked alternately.

The materials of each high refractive index layer and each low refractive index layer are not particularly limited, but may be selected in consideration of a required degree of antireflection, required productivity, and so on.

Regarding the material constituting the high refractive index layer, a material containing at least one selected from the group consisting of niobium, titanium, zirconium, tantalum and silicon can be used preferably. Specific examples of such materials include niobium oxide (Nb₂O₅), titanium oxide (TiO₂), zirconium oxide (ZrO₂), tantalum oxide (Ta₂O₅) and silicon nitride.

Regarding the material constituting the low refractive index layer, a material containing silicon can be used preferably. Specific examples of such materials include silicon oxide (SiO₂), a material containing a mixed oxide of Si and Sn, a material containing a mixed oxide of Si and Zr, and a material containing a mixed oxide of Si and Al.

A method for forming the antireflection layer is not particularly limited, but various methods can be used. Particularly, it is preferable to form the antireflection layer by a method such as pulse sputtering, AC sputtering, or digital sputtering.

The thickness of the antireflection layer is, for example, about 100 nm to 300 nm.

### «Antiglare Layer»

The antiglare layer has a surface concave-convex shape that diffuses and reflects external light to thereby make a reflected image unclear and provide an antiglare effect and the like. Due to provision of the antiglare layer, it is possible to reduce glare of the external light when an image displayed on the display panel is viewed. Thus, the displayed image can be visually recognized clearly.

A method for forming the antiglare layer is not particularly limited. For example, a method in which the surface layer of the glass is etched, a method in which coating liquid containing fine particles and a matrix is applied onto the surface of the glass, etc. can be used.

### «Antifouling Layer»

The antifouling layer is a layer which suppresses adhesion of organic substances or inorganic substances, or a layer which provides an effect that even when organic substances or inorganic substances are adhered thereon, the adhered substances can be removed easily by cleaning such as wiping. Due to provision of the antifouling layer, even when the surface (first main face) of the first glass is touched by fingers, no fingerprint remains on the surface of the first glass, so that the surface of the first glass can be kept clean. Thus, when an image displayed on the display panel is viewed, the displayed image can be visually recognized clearly.

### <Method for Manufacturing Laminate>

A method for manufacturing the laminate of the invention is not particularly limited. A method similar to a method for manufacturing a laminated glass as known in the background art can be used.

For example, the intermediate film is disposed between the first glass and the second glass, and then pressed on predetermined pressing conditions to obtain a laminated glass.

The pressing conditions are not particularly limited. For example, the pressing pressure is preferably 0.5 to 3.0 MPa, and more preferably 1.0 to 2.0 MPa. The pressing temperature is preferably 70 to 200° C., and more preferably 90 to 160° C. The pressing time is preferably 5 to 60 minutes, and more preferably 10 to 40 minutes.

### EXAMPLES

The present invention will be described below more specifically with examples. However, the present invention is not limited to the following examples.

### (Manufacturing of Laminate)

Laminates in Examples were manufactured to have different values as the thickness t₁ (unit: mm) of the first glass, the thickness t₂ (unit: mm) of the second glass, the storage shear elastic modulus x (unit: GPa) of the intermediate film at a temperature of 25° C. and a frequency of 10 kHz, and the thickness t₃ (unit: mm) of the intermediate film, as shown in Table 1.

Specifically, the intermediate film made of EVA was disposed between the first glass and the second glass, and the thus-obtained stack was pressed for 20 minutes on conditions of a pressure of 1.3 MPa and a temperature of 130° C. In this manner, each laminate that was a laminated glass was manufactured.

A chemically-strengthened glass in which chemically strengthening treatment had been performed on an aluminosilicate glass (“Dragontrail (registered trademark)” made by AGC Inc.) for use in chemically strengthening was used as each of the first glass and the second glass. In the chemically-strengthened glass, the thickness (DOL) of a compressive stress layer was set at 35 μm and the surface compressive stress (CS) in the compressive stress layer was set at 750 MPa.

### (Evaluation of Shock Resistance by Head Impactor Test)

Using the laminate in each Example, a head impactor test was performed in the following manner to evaluate the shock resistance of the laminate.

### «Manufacturing of Test Body»

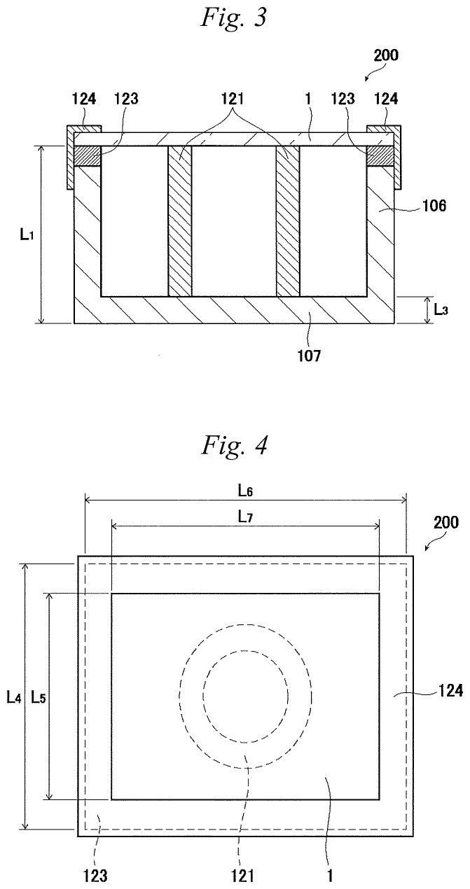

A test body of an in-vehicle display device was manufactured using the laminate in each Example. The manufactured test body will be explained with reference to FIG. 3 and FIG. 4.

FIG. 3 is a cross-sectional view illustrating a test body 200. FIG. 4 is a plan view illustrating the test body 200.

In FIG. 3 and FIG. 4, parts the same as (or corresponding to) those of the display device 100 in FIG. 1 are referenced correspondingly, and description thereof may be omitted.

As illustrated in FIG. 3 and FIG. 4, the test body 200 includes a housing 106 including a housing bottom plate 107. Inside the housing 106, a cylindrical ring 121 is disposed. The ring 121 is disposed at the center of the housing 106. One end face of the ring 121 is in contact with the housing bottom plate 107. The laminate 1 is disposed on the other end face of the ring 121. A polyacetal (POM) material 123 made of POM is disposed like a frame between a side wall part of the housing 106 and the laminate 1. The laminate 1, the POM material 123 and the side wall part of the housing 106 are fixed by a tape 124.

Sizes expressed by L₁ to L₇ in FIG. 3 and FIG. 4 are as provided below.

L₁: 65 mm

L₃: 10 MM

L₄: 300 mm

L₅: 260 mm

L₆: 300 mm

L₇: 260 mm

Respective portions of the test body 200 will be described in detail below. Incidentally, the parameters used in the aforementioned simulation will be also described below.

First glass 11 and second glass 12 . . . Young's modulus: 74 GPa, Poisson's ratio: 0.23, density: 2.48 g/cm³

Intermediate film 13 . . . Poisson's ratio: 0.45, density: 1 g/cm³

Housing 106 (including housing bottom plate 107) . . . material: SS400, Young's modulus: 206 GPa, Poisson's ratio: 0.3, density: 7.85 g/cm³

Ring 121 . . . material: POM material (polyacetal), Young's modulus: 2.71 GPa, Poisson's ratio: 0.3, density: 1 g/cm³

POM material . . . polyacetal made by KARATANI Corporation, Young's modulus: 2.71 GPa, Poisson's ratio: 0.3, density: 1 g/cm³

Tape 124 . . . P-cut tape No. 4140 made by Teraoka Seisakusho Co., Ltd., Young's modulus: 1 GPa, Poisson's ratio: 0.35, density: 1 g/cm³

### «Head Impactor Test»

A head impactor test was performed on each of the manufactured test bodies. Specifically, a bottom face of the test body 200 was fixed on the horizontal plane, and a spherical rigid model (material: iron, diameter: 165 mm, mass: 12.9 kg) was made to fall down toward the central position of the laminate in the fixed test body, and collided with the fixed test body, so that energy at the collision reached 16 J.

### «Evaluation of Shock Resistance»

After the head impactor test, the existence of breaking in the first glass and the second glass of the laminate was visually confirmed. When no breaking was confirmed in a glass, the glass was evaluated as “A” in the following Table 1. When breaking was confirmed in a glass, the glass was evaluated as “B” in Table 1. When a glass is evaluated as “A”, the glass is excellent in shock resistance.

TABLE 1

| | first glass | second glass | | intermediate film | | | | | | | | shock | |
|---|---|---|---|---|---|---|---|---|---|---|---|---|---|
| | thickness | thickness | intermediate film | thickness | | Expression | | | Expression | | Expression | resistance | |
| | t₁ | t₂ | elastic modulus x | t₃ | Expression (2) | (3) | Expression (4) | Expression (1) | (6) | Expression (7) | (5) | first | second |
| | [mm] | [mm] | [GPa] | [mm] | b₁ | b₂ | b₃ | B₁ (b₁ + b₂ + b₃) | b₄ | b₅ | B₂ (b₄ + b₅) | glass | glass |
| Ex. 1 | 0.7 | 0.7 | 0.176 | 0.4 | 0.689 | 0.793 | 0.795 | 2.276 | 1.26 | 2.62 | 3.88 | A | B |
| Ex. 2 | 0.7 | 1.1 | 0.176 | 0.4 | 0.612 | 0.793 | 0.795 | 2.200 | 1.30 | 2.62 | 3.92 | A | B |
| Ex. 3 | 0.7 | 2.0 | 0.176 | 0.4 | 0.441 | 0.793 | 0.795 | 2.029 | 1.38 | 2.62 | 4.00 | A | B |
| Ex. 4 | 0.7 | 0.7 | 0.176 | 1.2 | 0.689 | 0.793 | 0.795 | 2.277 | 1.26 | 2.45 | 3.71 | A | A |
| Ex. 5 | 0.7 | 1.1 | 0.176 | 1.2 | 0.612 | 0.793 | 0.795 | 2.201 | 1.30 | 2.45 | 3.75 | A | A |
| Ex. 6 | 0.7 | 2.0 | 0.176 | 1.2 | 0.441 | 0.793 | 0.795 | 2.030 | 1.38 | 2.45 | 3.83 | A | B |
| Ex. 7 | 0.7 | 0.7 | 0.088 | 0.4 | 0.689 | 0.904 | 0.891 | 2.484 | 1.26 | 2.45 | 3.71 | A | A |
| Ex. 8 | 0.7 | 1.1 | 0.088 | 0.4 | 0.612 | 0.904 | 0.891 | 2.407 | 1.30 | 2.45 | 3.74 | A | A |
| Ex. 9 | 0.7 | 2.0 | 0.088 | 0.4 | 0.441 | 0.904 | 0.891 | 2.236 | 1.38 | 2.45 | 3.83 | A | B |
| Ex. 10 | 0.7 | 0.7 | 0.088 | 1.2 | 0.689 | 0.904 | 0.898 | 2.491 | 1.26 | 2.27 | 3.53 | A | A |
| Ex. 11 | 0.7 | 1.1 | 0.088 | 1.2 | 0.612 | 0.904 | 0.898 | 2.415 | 1.30 | 2.27 | 3.57 | A | A |
| Ex. 12 | 0.7 | 2.0 | 0.088 | 1.2 | 0.441 | 0.904 | 0.898 | 2.243 | 1.38 | 2.27 | 3.65 | A | A |
| Ex. 13 | 1.1 | 0.7 | 0.176 | 0.4 | 0.882 | 0.793 | 0.795 | 2.470 | 1.23 | 2.62 | 3.85 | A | B |
| Ex. 14 | 1.1 | 1.1 | 0.176 | 0.4 | 0.817 | 0.793 | 0.795 | 2.405 | 1.26 | 2.62 | 3.88 | A | B |
| Ex. 15 | 1.1 | 2.0 | 0.176 | 0.4 | 0.670 | 0.793 | 0.795 | 2.258 | 1.32 | 2.62 | 3.94 | A | B |
| Ex. 16 | 1.1 | 0.7 | 0.176 | 1.2 | 0.882 | 0.793 | 0.795 | 2.471 | 1.23 | 2.45 | 3.68 | A | A |
| Ex. 17 | 1.1 | 1.1 | 0.176 | 1.2 | 0.817 | 0.793 | 0.795 | 2.405 | 1.26 | 2.45 | 3.71 | A | A |
| Ex. 18 | 1.1 | 2.0 | 0.176 | 1.2 | 0.670 | 0.793 | 0.795 | 2.258 | 1.32 | 2.45 | 3.77 | A | A |
| Ex. 19 | 1.1 | 0.7 | 0.088 | 0.4 | 0.882 | 0.904 | 0.891 | 2.677 | 1.23 | 2.45 | 3.68 | A | A |
| Ex. 20 | 1.1 | 1.1 | 0.088 | 0.4 | 0.817 | 0.904 | 0.891 | 2.612 | 1.26 | 2.45 | 3.70 | A | A |
| Ex. 21 | 1.1 | 2.0 | 0.088 | 0.4 | 0.670 | 0.904 | 0.891 | 2.465 | 1.32 | 2.45 | 3.77 | A | A |
| Ex. 22 | 1.1 | 0.7 | 0.088 | 1.2 | 0.882 | 0.904 | 0.898 | 2.684 | 1.23 | 2.27 | 3.50 | A | A |
| Ex. 23 | 1.1 | 1.1 | 0.088 | 1.2 | 0.817 | 0.904 | 0.898 | 2.619 | 1.26 | 2.27 | 3.53 | A | A |
| Ex. 24 | 1.1 | 2.0 | 0.088 | 1.2 | 0.670 | 0.904 | 0.898 | 2.472 | 1.32 | 2.27 | 3.59 | A | A |
| Ex. 25 | 2.0 | 0.7 | 0.176 | 0.4 | 1.318 | 0.793 | 0.795 | 2.906 | 1.09 | 2.62 | 3.72 | B | A |
| Ex. 26 | 2.0 | 1.1 | 0.176 | 0.4 | 1.277 | 0.793 | 0.795 | 2.865 | 1.10 | 2.62 | 3.72 | A | A |
| Ex. 27 | 2.0 | 2.0 | 0.176 | 0.4 | 1.183 | 0.793 | 0.795 | 2.771 | 1.11 | 2.62 | 3.73 | A | A |
| Ex. 28 | 2.0 | 0.7 | 0.176 | 1.2 | 1.318 | 0.793 | 0.795 | 2.907 | 1.09 | 2.45 | 3.55 | B | A |
| Ex. 29 | 2.0 | 1.1 | 0.176 | 1.2 | 1.277 | 0.793 | 0.795 | 2.865 | 1.10 | 2.45 | 3.55 | A | A |
| Ex. 30 | 2.0 | 2.0 | 0.176 | 1.2 | 1.183 | 0.793 | 0.795 | 2.772 | 1.11 | 2.45 | 3.56 | A | A |
| Ex. 31 | 2.0 | 0.7 | 0.088 | 0.4 | 1.318 | 0.904 | 0.891 | 3.113 | 1.09 | 2.45 | 3.54 | B | A |
| Ex. 32 | 2.0 | 1.1 | 0.088 | 0.4 | 1.277 | 0.904 | 0.891 | 3.072 | 1.10 | 2.45 | 3.55 | B | A |
| Ex. 33 | 2.0 | 2.0 | 0.088 | 0.4 | 1.183 | 0.904 | 0.891 | 2.978 | 1.11 | 2.45 | 3.56 | B | A |
| Ex. 34 | 2.0 | 0.7 | 0.088 | 1.2 | 1.318 | 0.904 | 0.898 | 3.120 | 1.09 | 2.27 | 3.37 | B | A |
| Ex. 35 | 2.0 | 1.1 | 0.088 | 1.2 | 1.277 | 0.904 | 0.898 | 3.079 | 1.10 | 2.27 | 3.37 | B | A |
| Ex. 36 | 2.0 | 2.0 | 0.088 | 1.2 | 1.183 | 0.904 | 0.898 | 2.985 | 1.11 | 2.27 | 3.39 | B | A |

As shown in the aforementioned Table 1, when Expression (1) “Bᵢ=b₁+b₂+b₃<2.90” was satisfied, breaking of the first glass could be suppressed.

In addition, when Expression (5) “B₂=b₄+b₅≤3.82” was satisfied, breaking of the second glass could be suppressed.

The present application is based on Japanese patent application No. 2018-095184 filed on May 17, 2018, and the contents of which are incorporated herein by reference.

### DESCRIPTION OF REFERENCE NUMERALS AND SIGNS

1 laminate

11 first glass

11a first main face

11b second main face

12 second glass

12a first main face

12b second main face

13 intermediate film

14 adhesive layer

100 display device

102 backlight unit

104 display panel

106 housing

107 housing bottom plate

121 ring

123 POM material

124 tape

200 test body

What is claimed is:

1. A laminate comprising a first glass, an intermediate film and a second glass in this order, the laminate satisfying the following Expressions (1) to (4):
B₁=b₁+b₂+b₃<2.90, (1)
b₁=(0.0665t₂+0.4378)t₁+(−0.2367t₂+0.5152), (2)
b₂=−0.16 Ln(x)+0.5152, and (3)
b₃=(0.0785x²−0.1135x+0.0182)t₃+(−0.134 Ln(x)+0.5617), (4)
in which t₁ is a thickness of the first glass in millimeter unit, t₂ is a thickness of the second glass in millimeter unit, t₃ is a thickness of the intermediate film in millimeter unit, and x is a storage shear elastic modulus of the intermediate film at a temperature of 25° C. and a frequency of 10 kHz in GPa unit.

2. The laminate according to claim 1, further satisfying the following Expressions (5) to (7):
B₂=b₄+b₅≤3.82, (5)
b₄=(−0.0612t₁+0.1357)t₂−0.0596t₁²+0.0769t₁+1.1698, and (6)
b₅=−0.1079t₃+0.1282 Ln(x)+1.5774+(0.0047t₃+0.1231)Ln(x)−0.0963t₃+1.5660. (7)

3. The laminate according to claim 2, further satisfying the following Expression (8) as to the B₂:
B₂<3.77. (8)

4. The laminate according to claim 1, wherein at least one of the first glass and the second glass is a chemically-strengthened glass.

5. The laminate according to claim 1, wherein both the first glass and the second glass are chemically-strengthened glasses.

6. The laminate according to claim 4, wherein the chemically-strengthened glass has a compressive stress layer, the compressive stress layer has a thickness of 10 μm or more, and the compressive stress layer has a surface compressive stress of 500 MPa or more.

7. The laminate according to claim 1, wherein the thickness t₁ of the first glass is 0.5 mm or more and 3 mm or less.

8. The laminate according to claim 1, wherein the thickness t₂ of the second glass is 0.5 mm or more and 3 mm or less.

9. The laminate according to claim 1, wherein the storage shear elastic modulus x of the intermediate film is 0.040 GPa or more and 0.800 GPa or less.

10. The laminate according to claim 1, wherein the thickness t₃ of the intermediate film is 0.1 mm or more and 5 mm or less.

11. The laminate according to claim 1, having an adhesive strength between the first glass and the intermediate film of 0.1 N/25 mm or more.

12. The laminate according to claim 1, having an adhesive strength between the second glass and the intermediate film of 0.1 N/25 mm or more.

13. The laminate according to claim 1, wherein a resin constituting the intermediate film comprises at least one selected from the group consisting of polyvinyl butyral, ethylene vinyl acetate, and cycloolefin.

14. The laminate according to claim 1, having a luminous transmittance of 20% or more and 85% or less.

15. The laminate according to claim 1,
wherein the first glass comprises a first main face that is one of main faces thereof, and a second main face that is the other main face,
the second main face is bonded to the intermediate film, and
the laminate comprises a functional layer provided on the first main face.

16. The laminate according to claim 15, wherein the functional layer comprises at least one layer selected from the group consisting of an antireflection layer, an antiglare layer and an antifouling layer.

17. A display device comprising:
a display panel; and
the laminate according to claim 1,
wherein the laminate is a cover member that covers the display panel.

18. The display device according to claim 17, wherein the display device is an in-vehicle display device.
